(19) United States
(12) Patent Application Publication
(10) Pub. No.: US 2016/0054820 A1
(43) Pub. Date: Feb. 25, 2016

(54) A STYLUS PROVIDING HAPTIC FEEDBACK

(71) Applicant: KOC UNIVERSITESI, Istambul (TR)

(72) Inventors: Tevfik Metin Sezgin, Sariyer, Istanbul (TR); Cagatay Basdogan, Sariyer, Istanbul (TR); Atakan Arasan, Sariyer, Istanbul (TR)

(21) Appl. No.: 14/784,545

(22) PCT Filed: Apr. 14, 2013
(86) PCT No.: PCT/EP2013/057748

§ 371 Date: Oct. 14, 2015

(51) Int. Cl. G06F 3/0354; G06F 3/01

(52) U.S. Cl. CPC G06F 3/03545; G06F 3/016

(57) ABSTRACT

Present invention provides a stylus (S), a stylus (S), which is adapted to be used with electronic devices and capable of providing haptic feedback, and an operation method for said stylus (S). Said stylus (S) comprises, at least one body (B); at least one tip (T); at least two vibration actuators (A1, A2); at least one driver (D1), which drives said actuators (A1, A2); at least one controller (C), which controls the operation of said actuators (A1, A2), and at least one means for communication, which enables communication between stylus (S) and said electronic device. Said method comprises the steps of receiving at least one signal from said electronic D2 device by means of at least one means for communication, which enables communication between stylus (S) and said electronic device, and which is provided in the stylus (S); controlling the operation of at least two vibrating actuators (A1, A2), which are provided in the stylus (S) and which are driven by at least one driver (D1), according to the received signal by at least one controller (C).

This application is a national stage entry application under 35 U.S.C. §371 of and claims priority under 35 U.S.C. §119(e) to PCT Patent Application Serial Number PCT/EP2013/057748 filed Apr. 14, 2013, which is incorporated by reference.

### TECHNICAL FIELD

Present invention is related to styluses, which provide different haptic feedback to users.

### PRIOR ART

With the developing technology of touch screens and smart screens (for example, a projection screen or a smart board), importance of the stylus type human machine interfaces, which are able to interact with electronic devices (for example, tablet computers, mobile phones etc.) comprising said screens, has increased. According to the ability of communicating with electronic devices (which comprise said screens), there are mainly two types of styluses available in the market; namely passive type styluses and active type styluses. Passive type styluses usually do not comprise any electrical components. Touch of passive type styluses to the touch screen of an electronic device is sensed by the touch screen of said device. On the other hand, active type styluses are able to communicate with the screens (touch screen or smart screen) of electronic devices. With this communication, some commands are able to be sent to said electronic device through the stylus (for example, a button may be placed on stylus, and by pressing said button, a command is sent to said system). Similarly, a haptic feedback is able to be sent to stylus from said electronic device and said haptic feedback is able to be reflected to users in different ways (for example, by using light sources, audio sources or vibration actuators).

In the state of the art, different haptic feedbacks are sent to the users through styluses. For example, in the patent document US2009135164A1, a stylus comprising a motor for feedback purposes is disclosed. A mass is attached to a rotor of said motor. According to this document, when a feedback signal is sent from an electronic device to the stylus, motor is energised. When said motor is energised, said mass rotates and a vibration haptic feedback is sensed by the user. However, in this system, haptic feedback sensed by the user is limited. Therefore, the interaction, which is created between the electronic device and user by the stylus, is also limited.

Patent documents US2006158440A1 and US2012127088A1 also disclose styluses with haptic feedback. However, similar to patent document US2009135164A1, these documents also have limited feedbacks.

### BRIEF DESCRIPTION OF THE INVENTION

Present invention provides a stylus, which is adapted to be used with electronic devices and capable of providing haptic feedback, and an operation method for said stylus. Said stylus comprises, at least one body; at least one tip; at least two vibration actuators; at least one driver, which drives said actuators; at least one controller, which controls the operation of said actuators, and at least one means for communication, which enables communication between stylus and said electronic device. Said method comprises the steps of, receiving at least one signal from said electronic device by means of at least one means for communication, which enables communication between stylus and said electronic device, and which is provided in the stylus; controlling the operation of at least two vibrating actuators, which are provided in the stylus and which are driven by at least one driver, according to the received signal by at least one controller.

In a preferred embodiment of the present invention, said stylus further comprises at least one rotating actuator, which is positioned between distal and proximal phalanx of human hand comprising a rotor rotating about the long axis of the body and whose operation is controlled by the controller; at least one another driver for driving said motor and at least one balanced rotating mass, which is attached to the rotor of the motor.

According to the present invention, by controlling the operation of the actuators and by using at least two actuators, different types of haptic feedbacks are provided to users. Furthermore, number of said haptic feedbacks is increased using and controlling the operation of a motor, which comprises at least one rotational mass in its rotor. Therefore, the present invention increases the user experience by providing improved haptic feedback to user.

### OBJECT OF THE INVENTION

The object of the present invention is to provide a stylus which provides haptic feedback to the user.

Another object of the present invention is to provide a stylus with different actuators.

### DESCRIPTION OF THE DRAWINGS

FIG. 1 shows a perspective view of the stylus of the invention.

FIG. 2 shows a block diagram of the stylus of the invention.

FIG. 3 shows excitation graphs and haptic feedback of the vibration actuators of the stylus.

FIG. 4 shows another excitation graphs and haptic feedback of the vibration actuators of the stylus.

FIG. 5 shows another excitation graphs and haptic feedback of the vibration actuators of the stylus.

FIG. 6 shows another excitation graph and haptic feedback of the vibration actuators of the stylus.

FIG. 7 shows another excitation graph and haptic feedback of the rotating actuator of the stylus.

FIG. 8 shows results of a user study about possible haptic feedbacks generated by the vibration actuators of the stylus.

The references in the figures may possess following meanings;
Stylus (S)
Body (B)
Tip (T)
Actuator (A1, A2)
Motor (M)
Rotating mass (L)
Control unit (C)
Driver (D1, D2)
Power source (P)
Receiver (R)
Transmitter (O)
Sensors (N)
Excitation graph of first actuator (1a, 2a, 3a, 5a)
Excitation graph of second actuator (1b, 2b, 3b, 5b)
Haptic feedback (1c, 2c, 3c, 5c)
Excitation graph of motor (4a, 4b)
Torque feedback (4c, 4d)
Stimulus duration (d)
Inter stimulus onset interval (IS)
Excitation power (ep)
First zone (I)
Second zone (II)
Third zone (III)
Forth zone (IV)

### DESCRIPTION OF THE INVENTION

Styluses are usually used for interacting with at least one display (e.g.

touch screen or smart screen) of electronic devices as well as different surfaces (for example a board or a table). By using stylus, users are able to interact with the data and the objects of said devices such as writing, drawing, drag-drop, pushing, throwing etc. According to the ability of communicating with said electronic devices, there are mainly two types of styluses; namely passive type stylus and active type stylus. Passive type styluses do not communicate with electronic devices, they are only touched to the screen and said touch is detected by screen. On the other hand, active type styluses are able to communicate with said electronic devices. A command may be sent to the electronic device through stylus or electronic device may send some signals (e.g. feedback signal) to the stylus. Therefore, in the present invention, a stylus, which provides improved haptic feedback to the user according to the signals sent from an electronic device, is provided.

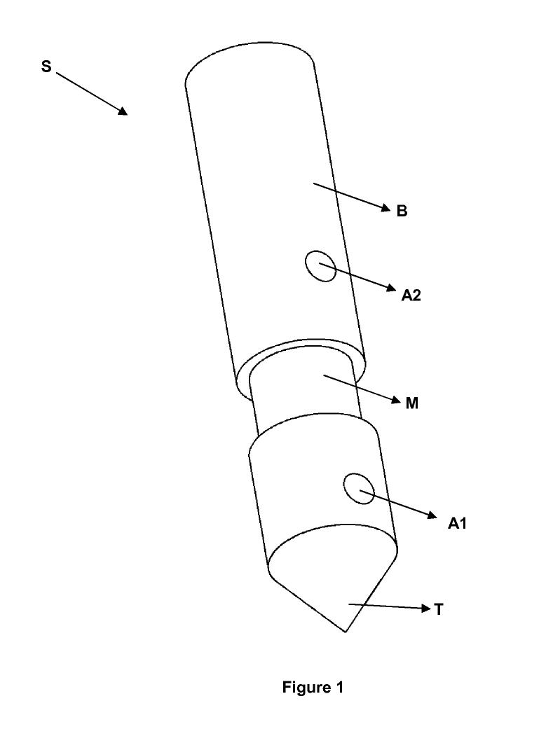

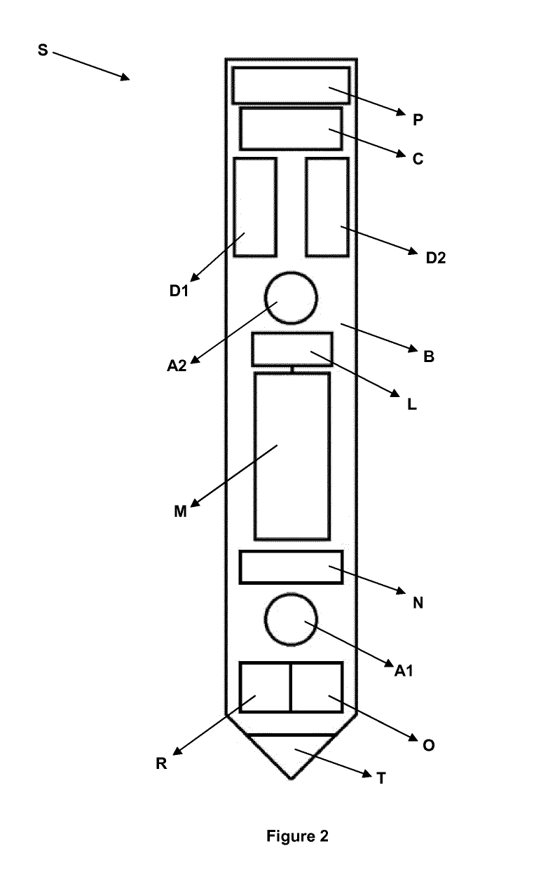

FIGS. 1 and 2 show exemplary views of the stylus (S) of the present invention. Stylus (S) of the present invention is able to be used with electronic devices preferably comprising at least one display. Said stylus (S) comprises at least one body (B), which is preferably in the cylindrical shape; at least one tip (T), which is at the one end of the body (B); at least two vibration actuators (A1, A2), which are placed at the body (B); at least one driver (D1), which drives said actuators (A1, A2); at least one controller (C), which controls the operation of said actuators (A1, A2) and at least one means for communication, which enables communication between stylus (S) and said electronic device. Each of said vibration actuators (A1, A2) comprises at least one vibrating end, where the vibration haptic feedback is generated. Said vibration actuators (A1, A2) are positioned on the body (B) close to distal and proximal phalanx of human hand when said stylus (S) is held by a user. According to present invention, said controller (C) controls the operation of said actuators (A1, A2) (preferably independently) so as to create haptic feedback to user.

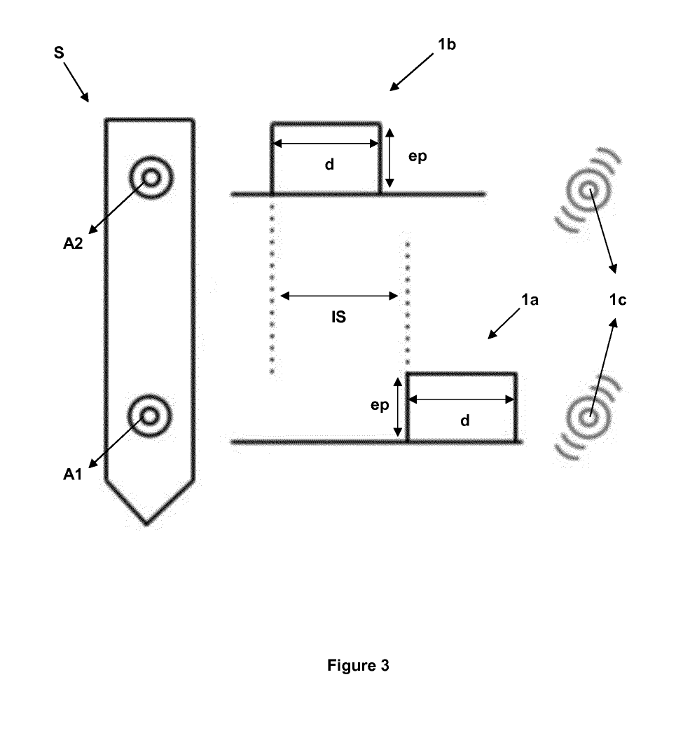

In the present invention, said vibration actuators (A1, A2) are excited with different excitations graphs (1a, 1b, 2a, 2b, 3a, 3b, 5a, 5b), which are shown in FIGS. 3-6 (the figures shown are for explanatory purposes only, they are not limiting the scope of the claim). According to said excitations graphs (1a, 1b, 2a, 2b, 3a, 3b), different haptic feedbacks (1c, 2c, 3c, 5c) are able to be sensed by the user. Sensed haptic feedback (1c, 2c, 3c) mainly depends on two parameters of said excitations graphs (1a, 1b, 2a, 2b, 3a, 3b). These two parameters are stimulus duration (d) and inter stimulus onset interval (IS) respectively. Said stimulus duration (d) is active (energised) duration of a vibration actuator (A1, A2) and said inter stimulus onset interval (IS) is time difference between activation (starting to be energised) of said vibrating actuators (A1, A2). Furthermore, excitation power (ep) of said vibration actuators (A1, A2) defines the intensity level of the sensed haptic feedback. In addition to said parameters, frequency of said vibration actuators (A1, A2) defines the perceptual space of vibration; spacing of said actuators (A1, A2) changes property of tactile effects (e.g. long effect, short effect), location of the vibrating actuators (A1, A2) on the body (B) and rotation direction of the vibrating actuators (A1, A2) also effects the characteristics of haptic feedback.

In an exemplary embodiment of the present invention, which is shown in FIG. 3, by adjusting the stimulus duration (d) and inter stimulus onset interval (IS) of the vibrating actuators (A1, A2), two discrete vibrations are sensed by the user as haptic feedback (1c). In this embodiment, the value of inter stimulus onset interval (IS) is preferably higher than the value of the stimulus duration (d). Furthermore, operations of the vibration actuators (A1, A2) are preferably controlled independently.

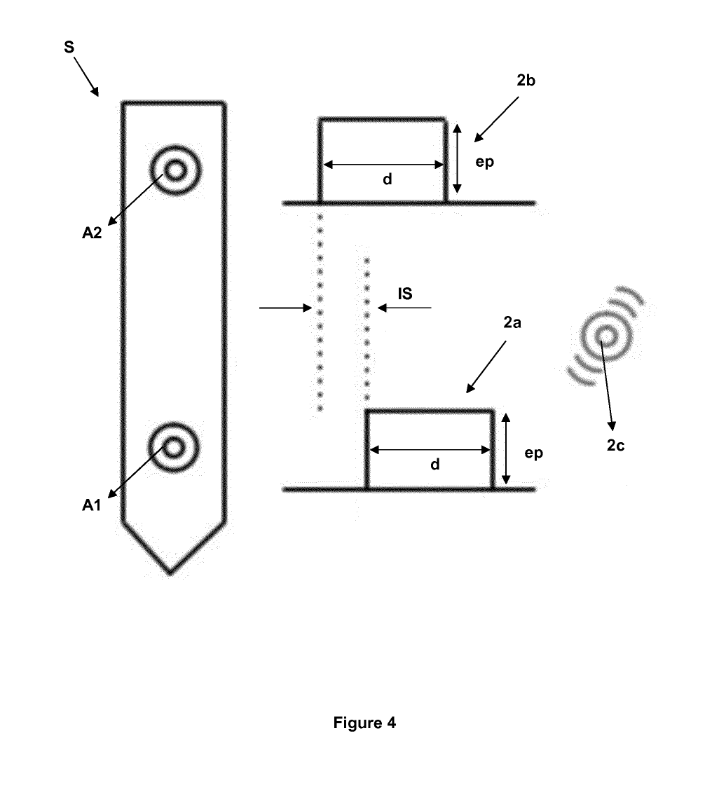

In another embodiment of the present invention, which is shown in FIG. 4, by adjusting the stimulus duration (d) and inter stimulus onset interval (IS) of the vibrating actuators (A1, A2), single vibration is sensed by the user as haptic feedback (2c). In this embodiment, the value of the inter stimulus onset interval (IS) is preferably lower than the value of the stimulus duration (d). Furthermore, in order to sense single vibration effect, values of inter stimulus onset interval (IS) and stimulus duration (d) are preferably lower than a threshold value (for example 200 ms). In this embodiment, location of the sensed single vibration is able to be adjusted by arranging the excitation power (ep) of the vibrating actuators (A1, A2) (in other words by arranging the levels of the excitation graphs (2a, 2b)).

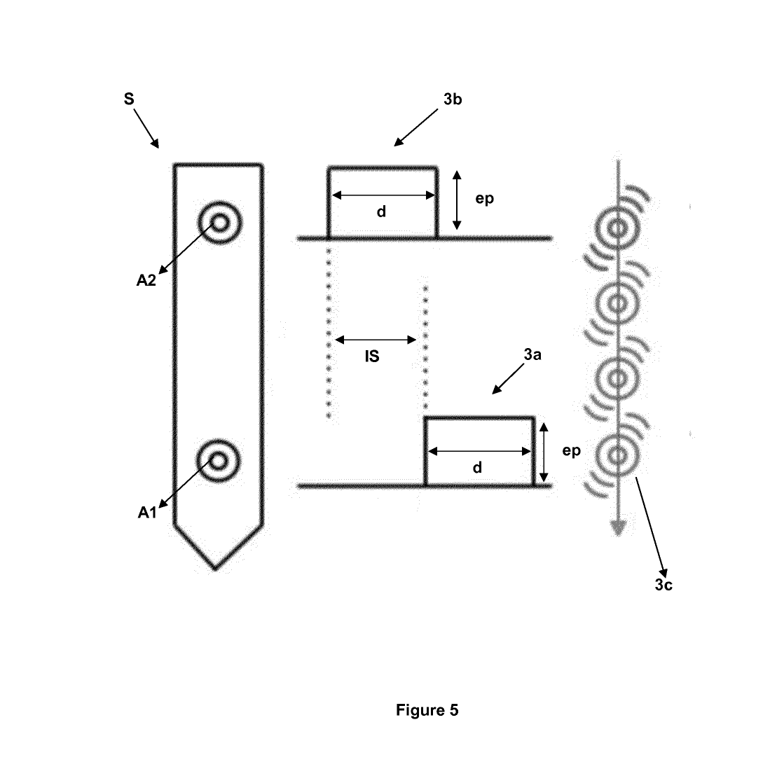

Another embodiment of the present invention is shown in FIG. 5. In this embodiment, the stimulus duration (d) and inter stimulus onset interval (IS) of the vibrating actuators (A1, A2) are adjusted so as to create a flow effect. In other words, according to this embodiment of the present invention, when vibrating actuators (A1, A2) are excited with excitations graphs (3a, 3b), a flowing vibration moving from one vibrating actuator (A1 or A2) to other vibrating actuator (A2 or A1) is sensed by the user. In this embodiment, the value of the inter stimulus onset interval (IS) is preferably lower than the value of the stimulus duration (d). Furthermore, in order to sense flow effect, value of stimulus duration (d) is preferably higher than a threshold value.

It has been found out that the feeling of the user depends on not only the stimulus duration (d) of the actuators (A1, A2), but also the time difference between actuation (IS) as shown in FIG. 8. By carefully controlling said parameters different haptic effects can be achieved. In the first zone (I) of FIG. 8, two different vibrations are sensed by the user as haptic feedback (1c). In the second zone (II), single vibration is sensed by the user as haptic feedback (2c). In the third zone (III), a single flowing vibration is sensed by the user as haptic feedback (3c). In the fourth zone (IV), sensed motion is not accurate for the users.

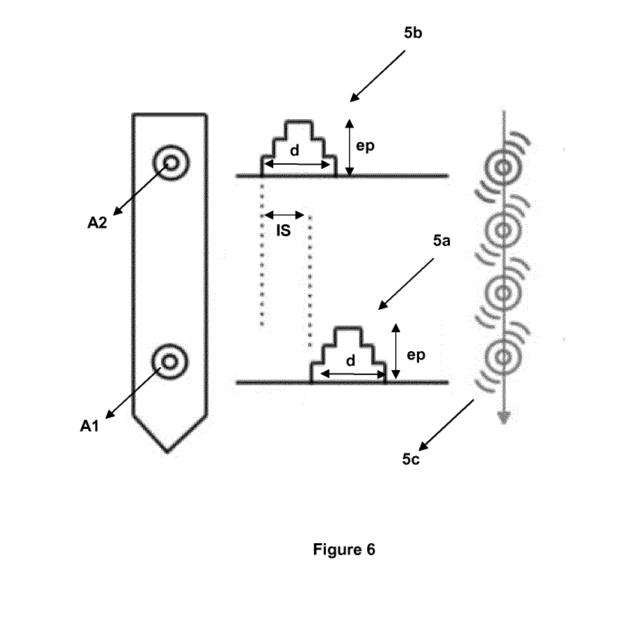

According to one another embodiment of the present invention (as shown in FIG. 6), by changing the excitation power (ep) of said vibrating actuators (A1, A2), a moving vibration effect is sensed by the user as haptic feedback (5c). In this embodiment, for each vibrating actuators (A1, A2), excitation power (ep) is firstly increased up to a predetermined level, and then decreased to another predetermined level. Therefore, a moving vibration effect, which moves from one vibrating actuator (A1 or A2) to another vibrating actuator (A2 or A1), is sensed by the user.

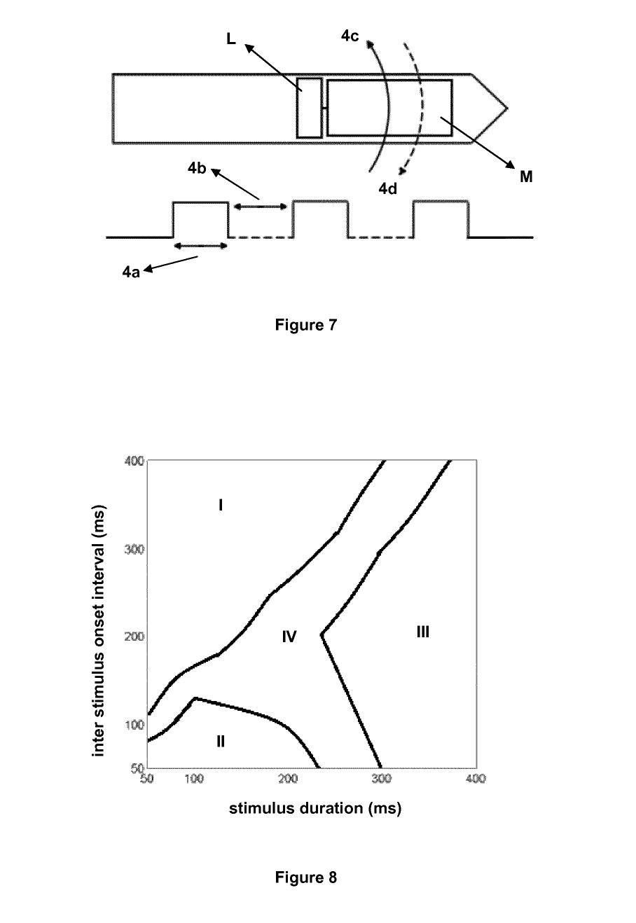

In a preferred embodiment of the present invention, stylus (S) further comprises at least one motor (M), which is placed in the body (B), whose rotor rotates about long axis of the body (B) and whose operation is controlled by the controller; at least one another driver (D2) for driving said motor (M) and preferably at least one rotating mass (L), which is attached to the rotor of the motor (M). In this embodiment (as shown in FIG. 7), when motor (M) is energised, rotating mass (L) starts rotating at one direction and creates a torque feedback (4c, 4d) in the opposite direction of rotation. When the motor (M) is de-energised, rotating mass (L) slows down (due to friction) and creates a reaction torque in the opposite direction. Therefore, by controlling the energising and de-energising durations and preferably repetition of actuation of the motor (M), torque feedback (4c, 4d) (rotational direction effect) perceived by the user is controlled. The figure shown is for explanatory purposes only, it is not limiting the scope of the claim. By changing the parameters intensity and location of excitation graphs of motor (4a, 4b), characteristics of the torque feedback (4c, 4d) can be changed. This method enables another haptic feedback for said stylus (S).

In a preferred embodiment, the stylus (S) may include at least one input sensor (N) that is configured to sense one or more characteristics of said stylus (S). Said sensors (N) might be force sensor, position sensor, torque sensor, pressure sensor, gyroscope, accelerometer, or thermistor. The haptic feedback may be generated by computing control signal of the actuators based on the data acquired from said sensors (N).

In a preferred embodiment of the present invention, means for communication comprises at least one wireless receiver (R), which is able to receive signals from said electronic device by creating a wireless connection between the stylus (S) and said device. Said receiver (R) receives signals coming from the electronic device, and sends these signals to the controller (C). Then, controller (C) controls the operation of the actuators (A1, A2) and/or motor (M) according to received signal. In this embodiment, the stylus (S) may also comprise a power source (P), which is able to energise said actuators (A1, A2), controller (C), motor (M), drivers (D1, D2) and receiver (R).

In another preferred embodiment of the present invention, said means for communication further comprises at least one transmitter (O). Said transmitter (O) is able to transmit signals from stylus (S) to said electronic device by creating a wireless connection between the stylus (S) and said device. Said transmitter (O) sends data coming from the sensors (N) via said controller (C) then said electronic device can compute desired feedback signals to send said stylus (S) via said receiver (R).

In another preferred embodiment, means for connection comprises at least one cable connection which enables a communication between stylus (S) and said device. In this embodiment, at least one cable enables data exchange between the controller (C) and electronic device. In this embodiment, as well as using a power source (P) for energising said actuators (A1, A2), controller (C) and motor (M), at least one another cable, which is able to energise said actuators (A1, A2), controller (C) and motor (M) using the power of the electronic device, may be used.

In a preferred embodiment of the present invention, said control unit (C) and drivers (D1, D2) are separate components. Alternatively, in another embodiment of the present invention, said control unit (C) and at least one driver (D1, D2) are in the form of a single component. In this embodiment, said control unit (C) and at least one driver (D1, D2) occupy less space in the stylus (S).

According to the present invention, by controlling the operation of the actuators (A1, A2), different types of haptic feedbacks are provided to users. Furthermore, number of said haptic feedbacks is increased using and controlling the operation of a motor (M), which comprises at least one rotational mass (L) in its rotor. Therefore, stylus (S) of the present invention improves the user experience by providing improved haptic feedback to user.

1. A stylus (S), which is adapted to be used with electronic devices; capable of providing haptic feedback and comprising at least one body (B) and at least one tip (T), which is in the one end of the body (B) characterized in that said stylus (S) further comprises;
at least two vibration actuators (A1, A2) which are placed at the body (B);
at least one driver (D1), which drives said actuators (A1, A2);
at least one controller (C), which controls the operation of said actuators (A1, A2), and
at least one means for communication, which enables communication between stylus (S) and said electronic device.

2. A stylus (S) according to claim 1 characterized in that; the stylus (S) provides single vibration effect.

3. A stylus (S) according to claim 1 characterized in that; the stylus (S) provides discrete vibration effects.

4. A stylus (S) according to claim 1 characterized in that; the stylus (S) provides flow effect.

5. A stylus (S) according to claim 1 characterized in that; stylus (S) further comprises at least one motor (M), which is placed in the body (B), which comprises a rotor rotating about the long axis of the body (B) and whose operation is controlled by the controller (C); and at least one another driver (D2) for driving said motor (M).

6. A stylus (S) according to claim 5 characterized to produce a torque feedback about the long axis of the stylus (S) in clockwise and counter clockwise direction.

7. A stylus (S) according to claim 5 characterized in that; said stylus (S) further comprises at least one balanced rotating mass (L) at the rotor of the motor (M).

8. A stylus (S) according to claim 1 characterized in that; said means for communication comprises at least one wireless receiver (R), which is able to receive signals from said electronic device by creating a wireless connection between the stylus (S) and said device.

9. A stylus (S) according to claim 1 characterized in that; said means for communication comprises at least one transmitter (O) which is able to transmit signals from stylus (S) to said electronic device by creating a wireless connection between the stylus (S) and said device.

10. A stylus (S) according to claim 1 characterized in that; said stylus (S) comprises a power source (P).

11. An operation method for a stylus (S), adapted to be used with electronic devices, and which comprises at least one body (B); at least one tip (T), which is in the one end of the body (B) characterized in that; the method comprises the steps of,
receiving at least one signal from said electronic device by means of at least one means for communication, which enables communication between stylus (S) and said electronic device, and which is provided in the stylus (S);
controlling the operation of at least two vibrating actuators (A1, A2), which are provided in the stylus (S) and which are driven by at least one driver (D1), according to the received signal by at least one controller (C).

12. A method according to claim 11 characterized in that; step of controlling the operation of at least two vibrating actuators (A1, A2) comprises adjusting stimulus duration (d), inter stimulus onset interval (IS) and excitation powers (ep) of said vibrating actuators (A1, A2).

13. A method according to claim 11 or 12 characterized in that; step of controlling the operation of at least two vibrating actuators (A1, A2) further comprises adjusting frequency and shape of control signals applied to the vibration actuators of excitations graphs (1a, 1b, 2a, 2b, 3a, 3b, 5a, 5b).

14. A method according to claims 11-13 characterized in that; step of controlling the operation of at least two vibrating actuators (A1, A2) further comprises adjusting location of said vibrating actuators (A1, A2).

15. A method according to claims 11-14 characterized in that; step of controlling the operation of at least two vibrating actuators (A1, A2) further comprises adjusting spacing of said vibrating actuators (A1, A2).

16. A method according to claims 11-15 characterized in that; step of controlling the operation of at least two vibrating actuators (A1, A2) further comprises adjusting rotation direction of said vibrating actuators (A1, A2).

17. A method, according to claim 11 characterized in that; said controller (C) controls the operation of at least one motor (M), which is placed in the body (B); which is driven by at least one another driver (D2), which comprises a rotor rotating about the long axis of the body (B).

18. A method according to claim 17 characterized in that; step of controlling the operation of at least one motor (M) further comprises adjusting repetition of said motor (M).

19. A method according to claim 17 characterized in that; step of controlling the operation of at least one motor (M) further comprises adjusting energising duration of said motor (M).

20. A method according to claim 17 characterized in that; step of controlling the operation of at least one motor (M) further comprises adjusting de-energising duration of said motor (M).

21. A method according to claim 17 characterized in that; step of controlling the operation of at least one motor (M) further comprises adjusting excitation power of said motor (M).
